(19) United States
(12) Patent Application Publication
(10) Pub. No.: US 2020/0032824 A1
(43) Pub. Date: Jan. 30, 2020

(54) THERMALLY EXPANDABLE CONNECTOR

(71) Applicant: Joy Global Underground Mining LLC, Warrendale, PA (US)

(72) Inventors: Edward Niederriter, Fryburg, PA (US); Ryan E. Perry, Venus, PA (US); Stephen Bremerkamp, Franklin, PA (US)

(21) Appl. No.: 16/523,874

(22) Filed: Jul. 26, 2019

Related U.S. Application Data
(63) Continuation of application No. 62/703,764, filed on Jul. 26, 2018.

(51) Int. Cl. F16B 3/00; E21B 15/00; F16B 5/00

(52) U.S. Cl. CPC F16B 3/00; E21C 11/00; E21C 25/10; F16B 2200/10; F16B 2200/50; F16B 5/0052

(57) ABSTRACT

A cutting device support for a mining machine includes a ranging arm, a bracket positioned adjacent an end of the ranging arm, and a thermally-expandable coupling member positioned between the bracket and the ranging arm. The coupling member exerts a force on the bracket and the ranging arm to secure the bracket to the ranging arm.

### CROSS-REFERENCE TO RELATED APPLICATION

This application claims the benefit of prior-filed, co-pending U.S. Provisional Patent Application No. 62/703,764, filed Jul. 26, 2018, the entire contents of which are incorporated by reference.

### TECHNICAL FIELD

The present disclosure relates to thermally expandable connectors, and particularly to a thermally expandable connector for mechanically coupling components of a machine for mining and/or excavation.

### BACKGROUND

Mining and excavation machines, for example longwall shearers, may include components that are joined to one another by welding.

### SUMMARY

In one aspect, a cutting device support for a mining machine including a ranging arm, a bracket positioned adjacent an end of the ranging arm, and a thermally-expandable coupling member positioned between the bracket and the ranging arm. The coupling member, while at a nominal temperature, exerts a force on the bracket and the ranging arm to secure the bracket to the ranging arm.

In another aspect, a method for attaching a bracket to an arm includes: aligning an end of the bracket adjacent an end of the arm; heating a coupling member to expand a dimension of the coupling member to a first value; positioning the coupling member to engage both the bracket and the arm; and cooling the coupling member until the dimension contracts to a second value less than the first value.

In another aspect, a support for a rock cutting device includes a bracket including a first groove; a support arm including a second groove proximate the first groove; and a coupling member for connecting the bracket and the support arm. The coupling member includes a first end positioned in the first groove and a second end positioned in the second groove. A dimension of the coupling member is expandable to a first value due to heating the coupling member and retractable to a second, nominal value due to cooling the coupling member. The coupling member exerts a force to secure the bracket to the support arm when the dimension is the nominal value.

Other independent aspects of the disclosure will become apparent by consideration of the detailed description, claims, and accompanying drawings.

### BRIEF DESCRIPTION OF THE DRAWINGS

FIG. 1 is a perspective view of a mining machine including a chassis and ranging arms.

FIG. 2 is exploded perspective view of a portion of the ranging arm of FIG. 1 and a coupling bracket.

FIG. 3 is an exploded view of the portion of the ranging arm and the coupling bracket of FIG. 2.

FIG. 4 is a perspective view of an end of the ranging arm with shims.

FIG. 5A is a cross-sectional view of a thermal beam securing a ranging arm and a coupling bracket.

FIG. 5B is a cross-sectional view of a thermal beam securing a ranging arm and a coupling bracket, according to another embodiment.

FIG. 6 is a cross-sectional view of a thermal beam.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

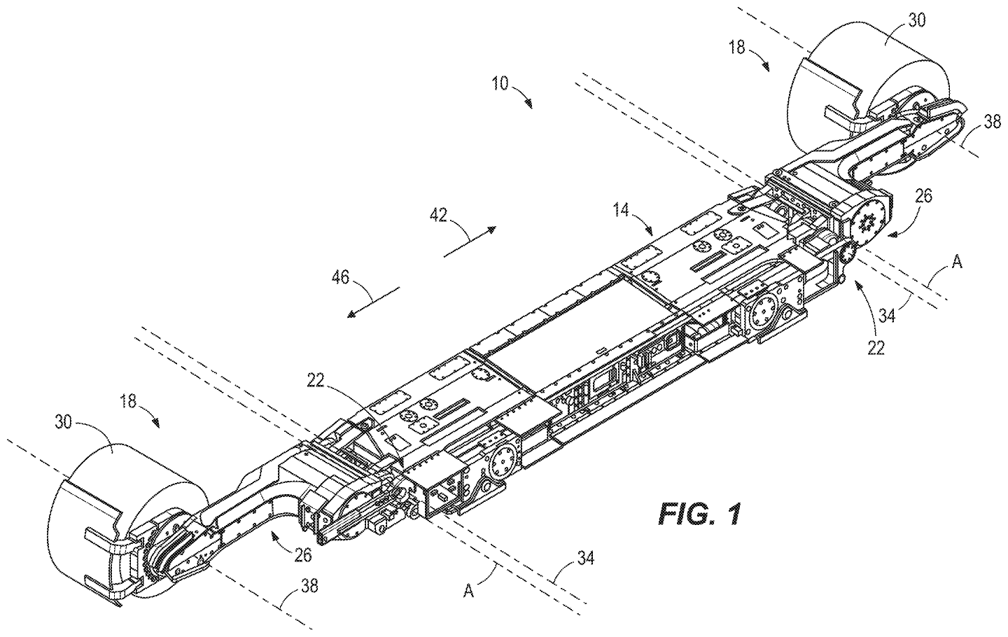

FIG. 1 illustrates a mining machine, such as a longwall shearer 10. In the illustrated embodiment, the shearer 10 includes a chassis or frame 14 and a pair of cutting assemblies 18. Each cutting assembly 18 includes a ranging arm 26 and a cutting drum 30. Each ranging arm 26 is pivotably coupled to an end of the chassis 14 and pivots about an arm axis 34. Each ranging arm 26 rotatably supports the associated cutting drum 30. Each cutting drum 30 includes a generally cylindrical body and cutting bits (not shown). In the illustrated embodiment, the drum 30 is coupled to the ranging arm 26 and is rotatable about a drum axis 38 that is substantially parallel to the arm axis 34. The frame 14 is configured to tram or move along a mine face or wall of material to be mined (e.g., coal—not shown) in a first direction 42 and a second direction 46. For simplicity, each drum 30 is illustrated in FIG. 1 as a cylindrical member.

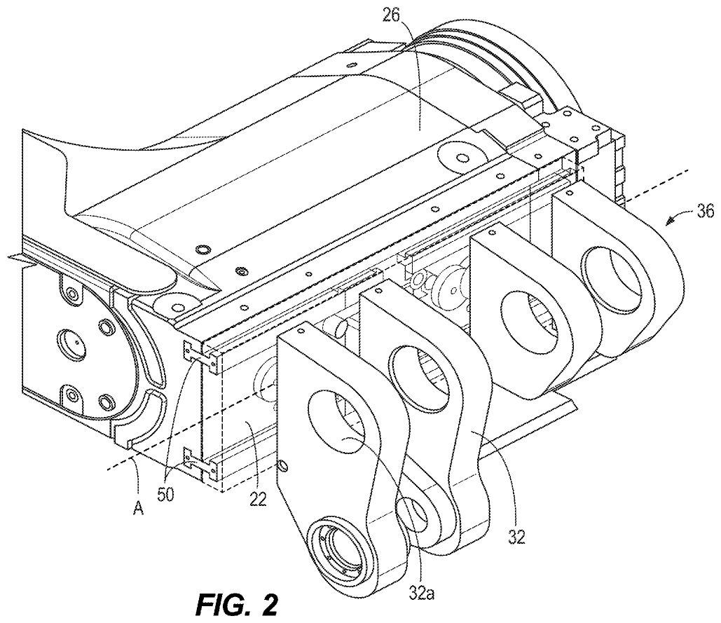

As shown in FIG. 2, in the illustrated embodiment, a coupling bracket 36 is secured to an end of the ranging arm 26. The bracket 36 includes lugs 32 that are pivotably coupled to a mating bracket (not shown) positioned on the chassis 14, thereby supporting the ranging arm 26 for pivoting movement. In order to secure the ranging arm 26 to the chassis 14, apertures 32a in the lugs 32 of the coupling bracket 36 are aligned with corresponding apertures of the mating bracket (not shown) and a pin (not shown) is positioned in the apertures, forming a hinge joint.

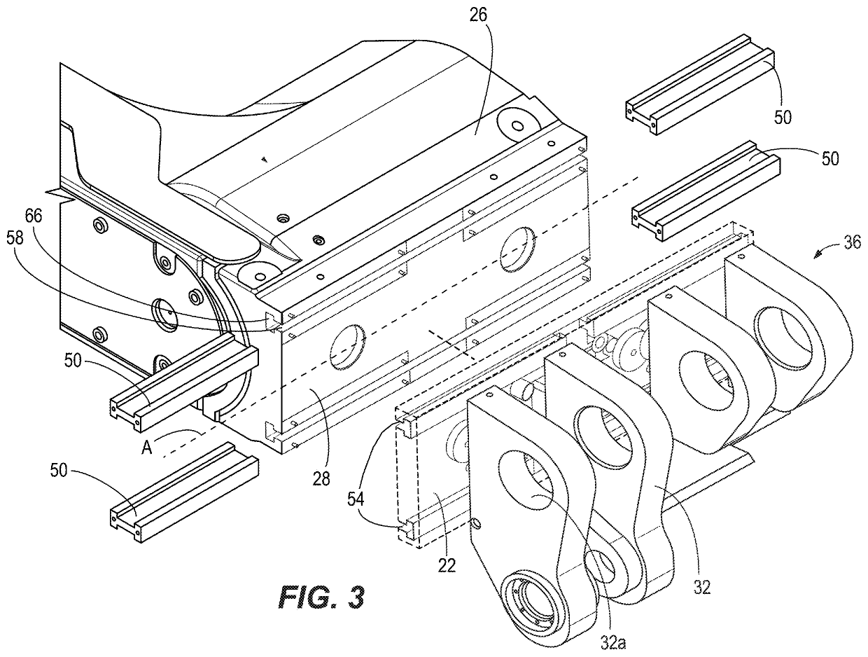

The bracket 36 further includes a butt plate 22 coupled to the lugs 32 and disposed between the arm 26 and the lugs 32. A surface of the butt plate 22 abuts an end surface 28 (FIG. 3) of the arm 26. As shown in FIGS. 2 and 3, coupling members or thermal beams 50 are disposed between the ranging arm 26 and the butt plate 22. The thermal beams 50 are oriented parallel to a beam axis A, extending at least partially along a length of an interface between the end surface 28 (FIG. 3) of the ranging arm 26 and the butt plate 22. A first groove 54 (FIG. 3) is positioned on the butt plate 22 of the bracket 36 and a second groove 58 is positioned on the end of the ranging arm 26. In the illustrated embodiment, the butt plate 22 includes two first grooves 54, and the end surface 28 includes two second grooves 58, each extending the length of the interface between the butt plate 22 and the end surface 28. In other embodiments, the butt plate 22 and end surface 28 may include fewer or more grooves, and/or the grooves may extend partially along the interface.

When the end surface 28 of the ranging arm 26 abutting the butt plate 22, each of the first grooves 54 is positioned adjacent and aligned with an associated second groove 58. One of the thermal beams 50 is positioned within the first groove 54 and second groove 58, thereby engaging both the end surface 28 and the butt plate 22. As shown in FIGS. 2 and 3, the thermal beam 50 extends between and secures the ranging arm 26 and the bracket 36. In the illustrated embodiment, two thermal beams 50 are positioned in each of the aligned grooves 54, 58. In other embodiments, fewer or more thermal beams 50 may engage the grooves 54, 58, and/or the thermal beams 50 may be arranged in a different configuration.

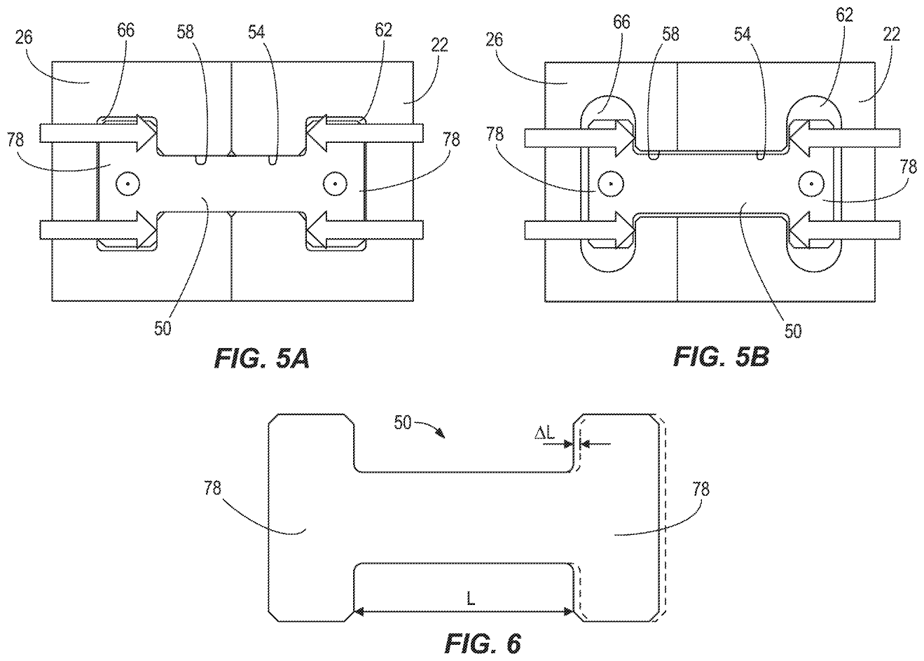

As best shown in FIG. 5A, in the illustrated embodiment, each of the grooves 54, 58 has a T-shaped profile. When the first groove 54 is aligned with the second groove 58, the grooves 54, 58 form a slot having an H-shaped profile, similar to the profile of the thermal beam 50. The thermal beam 50 is secured within the first and second grooves 54, 58, and the thermal beam 50 engages and applies a compressive load on the ranging arm 26 and the bracket 36. In the illustrated embodiment, the first groove 54 includes a first portion 62 and the second groove 58 includes a second portion 66. The first portion 62 and second portion 66 of the grooves may have substantially planar surfaces (FIG. 5A) or may have rounded (e.g., concave) surfaces (FIG. 5B). In other embodiments, the grooves 54, 58 and thermal beam 50 may have a different shape or profile.

Referring again to FIGS. 2 and 3, the thermal beam 50 can be coupled between the ranging arm 26 and the coupling bracket 36 while the butt plate 22 is positioned adjacent an end of the ranging arm 26 and the first groove 54 is aligned with the second groove 58. In particular, each beam 50 includes a pair of flanges 78, with one flange 78 positioned in the first portion 62 of the first groove 54 and the other flange positioned in the second portion 66 of the second groove 58 to exert a force on the ranging arm 26 and the bracket 36.

As shown in FIG. 6, the thermal beam 50 is heated to a first predetermined temperature, expanding the beam 50. Heating the beam 50 expands a distance between the flanges 78 to a first length or extended length. While the flanges 78 are spaced apart by the extended length, the beam 50 can be inserted parallel to axis A into the opening formed by the aligned first groove 54 of the bracket 36 and second groove 58 of the ranging arm 26. As the beam 50 cools to a second predetermined temperature (e.g., a nominal temperature or room temperature) lower than the first predetermined temperature, the distance between the flanges 78 of each beam 50 contracts to a second length or contracted length (e.g., a nominal length). In some embodiments, the beam 50 may be actively cooled, while in other embodiments the beam 50 may be allowed to cool. As shown in FIG. 5A, the thermal beam 50 engages the ranging arm 26 and bracket 36 in an interference fit, exerting a compressive preload on both the arm 26 and the bracket 36. The process may include completing the above steps for multiple beams 50.

The difference between the first predetermined temperature and the second predetermined temperature can be determined based upon a difference between the first length and the second length (FIG. 6). In order to control the necessary change in length, a user may adjust the difference between the first and second predetermined temperatures. The first and second predetermined temperatures are also based on the shape and the preload requirements of the thermal beam 50. Each groove 54, 58 may have a width to accommodate insertion of the beam 50 while the distance between the flanges 78 is at the expanded length.

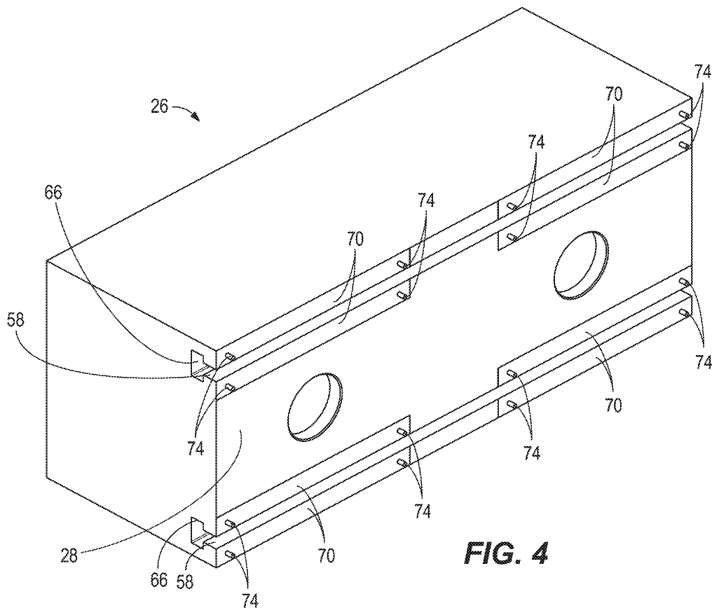

As shown in FIG. 4, in order to control and/or adjust the preload exerted by the thermal beams 50, the ranging arm 26 may include a shim 70. The shims 70 shown in FIG. 4 can be positioned along each of the grooves 54, 58. In other embodiments, the shim 70 may be installed in other positions and/or orientations. Pins or dowels 74 can also be installed on the end surface 28 of the ranging arm 26 or butt plate 22 in order to aid in assembling the shims 70 and/or the bracket 36. Following the installation of shims 70 and the bracket 36 on the ranging arm 26, the thermal beam 50 may be inserted into the first and second groove 54, 58 of the bracket 36 and the ranging arm 26.

As illustrated in FIGS. 2 and 3, attaching the bracket 36 to the ranging arm 26 by thermally expandable beams 50 provides greater versatility for inventory and reduces the number of unique parts that a supplier or manufacturer needs to maintain. During assembly of a conventional cutting assembly, each configuration of ranging arm and bracket may be associated with a particular type or model of chassis. As such, changing or substituting a ranging arm may require a ranging arm with an identical configuration and may be difficult, requiring a technician to have access to a large inventory of replacement parts. However, providing grooves 54, 58 in the ranging arm 26 and butt plate 22 simplifies assembly and permits the ranging arm 26 to be configured on demand by coupling it with a bracket 36 having the desired configuration for a particular chassis model.

Although the thermal beams 50 have been described above with respect to connecting a coupling bracket 36 to a ranging arm 26, thermal beams 50 may also be applied to other joints on the shearer 10, such as between a controller and a haulage frame.

Although various aspects have been described in detail with reference to certain embodiments, variations and modifications exist within the scope and spirit of one or more independent aspects as described. Various features and advantages are set forth in the following claims.

What is claimed is:

1. A cutting device support for a mining machine, comprising:
a ranging arm;
a bracket positioned adjacent an end of the ranging arm; and
a thermally expandable coupling member positioned between the bracket and the ranging arm, the coupling member, while at a nominal temperature, exerting a force on the bracket and the ranging arm to secure the bracket to the ranging arm.

2. The cutting device support for a mining machine of claim 1, further comprising a first groove and a second groove, wherein the first groove is positioned on the bracket and the second groove is positioned on the ranging arm opposite the first groove.

3. The cutting device support for a mining machine of claim 2, wherein the coupling member includes a first flange positioned within the first groove and a second flange positioned within the second groove.

4. The cutting device support for a mining machine of claim 1, further comprising a shim mounted on the bracket, wherein the shim is configured to adjust the preload force exerted by the coupling member.

5. The cutting device support for a mining machine of claim 1, wherein the ranging arm supports a cutting device and the bracket is configured to engage a chassis.

6. The cutting device support for a mining machine of claim 1, wherein the bracket supports the ranging arm for pivoting movement relative to the chassis about an axis.

7. The cutting device support for a mining machine of claim 1, wherein the coupling member is configured to be heated to a first temperature, and cooled to a second temperature lower than the first temperature.

8. The cutting device support for a mining machine of claim 7, wherein a dimension of the coupling member has a first value while the coupling member is at the first temperature, and the dimension of the coupling member has a second value while the coupling member is at the second temperature, the second value being less than the first value.

9. The cutting device support for a mining machine of claim 7, wherein the first temperature is selected based on at least one of a desired expansion length of a dimension of the coupling member and a preload requirement of the coupling member.

10. A method for attaching a bracket to an arm comprising:
aligning an end of the bracket adjacent an end of the arm;
heating a coupling member to expand a dimension of the coupling member to a first value;
positioning the coupling member to engage both the bracket and the arm; and
cooling the coupling member until the dimension contracts to a second value less than the first value.

11. The method of claim 10, wherein aligning the bracket with the arm further includes aligning a first groove on the bracket with a second groove on the arm.

12. The method of claim 11, wherein inserting the coupling member between the bracket and the arm includes positioning a first flange of the coupling member in the first groove and positioning a second flange of the coupling member in the second groove.

13. The method of claim 10, wherein preloading the coupling member further includes positioning a shim adjacent the bracket to adjust a loading force exerted by the coupling member on the bracket and the arm.

14. The method of claim 10, wherein heating the coupling member includes heating the coupling member to a first temperature, and cooling the coupling member includes cooling the coupling member to a second temperature.

15. The method of claim 14, further including determining the first temperature based on at least one of a desired difference between the first value and second value of the dimension, the shape of the coupling member, and the preload requirement of the coupling member.

16. The method of claim 10, wherein cooling the coupling member causes the coupling member to exert a preload force on each of the bracket and the arm.

17. The method of claim 10, wherein cooling the coupling member includes permitting the coupling member to cool passively.

18. A support for a rock cutting device comprising:
a bracket including a first groove;
a support arm including a second groove proximate the first groove; and
a coupling member for connecting the bracket and the support arm, the coupling member including a first end positioned in the first groove and a second end positioned in the second groove, a dimension of the coupling member being expandable to a first value due to heating the coupling member and retractable to a second, nominal value due to cooling the coupling member, the coupling member exerting a force to secure the bracket to the support arm when the dimension is the nominal value.

19. The cutting device support for a mining machine of claim 18, wherein the coupling member is configured to be heated to a first temperature, and cooled to a second temperature lower than the first temperature.

20. The cutting device support for a mining machine of claim 19, wherein the coupling member includes a pair of flanges spaced apart by a distance, the distance having the first length while at the first temperature and the distance having a second length while at the second temperature.
